(19) United States
(12) Patent Application Publication
(10) Pub. No.: US 2003/0006520 A1
(43) Pub. Date: Jan. 9, 2003

(54) Method of making a patterned artificial marble/granite/solid surface material

(76) Inventor: Kuo-Yuan Lin, Yungkang City (TW)

Correspondence Address: Alan Kamrath, RIDER BENNETT EGAN & ARUNDEL, LLP, Suite 2000, 333 South Seventh Street, Minneapolis, MN, 55402, US

(21) Appl. No.: 09/899,125

(22) Filed: Jul. 5, 2001

(51) Int. Cl. B29C 41/22; B29C 33/40

(52) U.S. Cl. 264/73; 264/219; 264/331.11; 264/331.12; 264/331.18; 264/331.21

(57) ABSTRACT

A method of making patterned artificial material marble/granite/solid surface material that makes artificial marble/granite/solid surface material with variable patterns by use of polymers. The polymers are combined with filler materials, an accelerating reagent or colorful material to compose basic materials and pattern materials in different colors. Molds with at least one pattern are used for curing of the basic materials and the pattern material to form the patterned artificial material and to make the artificial marble/granite/solid surface material integral.

### BACKGROUND OF THE INVENTION

1. Field of the Invention

The present invention relates to a method of making an artificial marble/granite/solid surface material, and more particularly to make an artificial marble/granite/solid surface material with variable patterns by use of polymers.

2. Description of Related Art

Patterned marble/granite/solid surface materials are widely used in architecture, table plate, or furniture to create an eye-catching decorative effect. The marble/granite/solid surface material usually has pebbles or minerals embedded therein and there are three different methods for making an artificial marble/granite/solid surface material with a pattern:

1. First method: Taking a natural marble/granite/solid surface material to be the main body, digging out hollows by hand in the natural marble/granite/solid surface material in correspondence with a specific pattern, and then trimming the edges of the hollows. Finally, the hollows are filled with decorative material such as marble/granite/solid surface material of a different color to finish the patterned marble/granite/solid surface material.

2. Second method: Cutting the natural marble/granite/solid surface material or artificial marble/granite/solid surface material into certain pieces for constructing the whole patterned marble/granite/solid surface material, and then fitting the pieces together one by one as in a puzzle to complete the pattern marble/granite/solid surface material.

3. Third method: Using computer-controlled engraving tools to sculpt the natural marble/granite/solid surface material or artificial marble/granite/solid surface material into a certain shape of pattern, and then combining other decorative material into the sculpted marble/granite/solid surface material.

The above-mentioned methods all can produce patterned marble/granite/solid surface material, however, there are several disadvantages existing such as production methods, product cost, product quality . . . etc.

(1) Ways of producing:

1. The first method for making the patterned marble/granite/solid surface material using natural marble/granite/solid surface material is based on handwork from cutting, trimming to embedding, and those procedures are time-consuming and manpower-wasting.

2. The second method for making the patterned marble/granite/solid surface material is to compose the whole patterned marble/granite/solid surface material piece by piece, therefore, the composing procedure is vexing. Each piece has to be cut from the natural marble/granite/solid surface material which is troublesome and cutting machines are easily worn out, both of which lead to a product that is not cost-effective.

3. The third method for making the pattern marble/granite/solid surface material is cutting the marble/granite/solid surface material by computer-controlled engraving tools. The computer-controlled engraving tools are expensive and the speed of sculpting is slow, so this method is of low efficiency and only suitable for small batches of work.

(2) Quality of product:

1. The first method for making patterned marble/granite/solid surface material involves using manual workers so that the pattern of the marble/granite/solid surface material is not precise, whereby the hollows of the main body can not always match with the embedded decorative material perfectly and surfaces of the patterned marble/granite/solid surface material are uneven and rough. Additionally, the natural marble/granite/solid surface material is easily corroded by acid or alkaline and thus fractures easily, leading to consumer dissatisfaction.

2. The second method for making a patterned marble/granite/solid surface material is to combine several pieces of cut natural marble/granite/solid surface material or artificial marble/granite/solid surface material together, therefore, the joints of these pieces collapse easily and the pattern of the marble/granite/solid surface material often deforms after fitting the pieces of marble/granite/solid surface material together. Besides, the piece made of natural marble/granite/solid surface material is also easily corroded by acid or alkaline to become fragile.

3. The third method for making a patterned marble/granite/solid surface material is by the use of computer-controlled engraving tools and has a precise result of the cutting or sculpting. However, the computer-controlled engraving tools have blind spots and can not sculpt some patterns at certain angles. Therefore, the pattern can not be complex or irregular.

(3) Manufacture

1. The first method for making a patterned marble/granite/solid surface material made by hand with natural marble/granite/solid surface material is only suitable for large patterns because the natural marble/granite/solid surface material has high hardness and is not easy to be dealt with by machine.

2. The second method for making a patterned marble/granite/solid surface material constructed piece by piece is only suitable for large patterns because when the pieces are multitudinous, the combination of the whole patterned marble/granite/solid surface material is excessively time-consuming.

3. The third method for making a patterned marble/granite/solid surface material made by computer-controlled engraving tools has some limitations such as angles in manufacturing.

(4) For environmental problems

1. In the first method for making a patterned marble/granite/solid surface material, the natural marble/granite/solid surface material needs to be cut or sculpted to form the whole marble/granite/solid surface material. Therefore, a lot of residue of the cut or sculpted is produced and the residue can not be reused, which causes environmental problems.

2. In the second method for making a patterned marble/granite/solid surface material, the same environmental problem with the first method exists in making a lot of residue.

3. In the third method for making a patterned marble/granite/solid surface material, the computer-controlled engraving tools create huge quantities of marble/granite/solid surface material powder, which pollutes the environment.

Therefore, in order to overcome above-mentioned disadvantages, the present invention has arisen to mitigate and/or obviate the disadvantages of the conventional methods for making patterned marble/granite/solid surface material.

### SUMMARY OF THE INVENTION

The main objective of the present invention is to provide a method of making a patterned artificial marble/granite/solid surface material that is low-cost, environmentally-friendly, and easy to produce.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a method of making patterned artificial marble/granite/solid surface material in accordance with the present invention;

FIGS. 2A-2G are plane views of embodiments of patterned artificial marble/granite/solid surface materials that are produced by the method in accordance with FIG. 1; and

FIGS. 3A-3C are plane views of embodiments of patterned artificial marble/granite/solid surface materials and the embodiments show the derivative variation in one patterned artificial marble/granite/solid surface material.

### DETAILED DESCRIPTION OF THE INVENTION

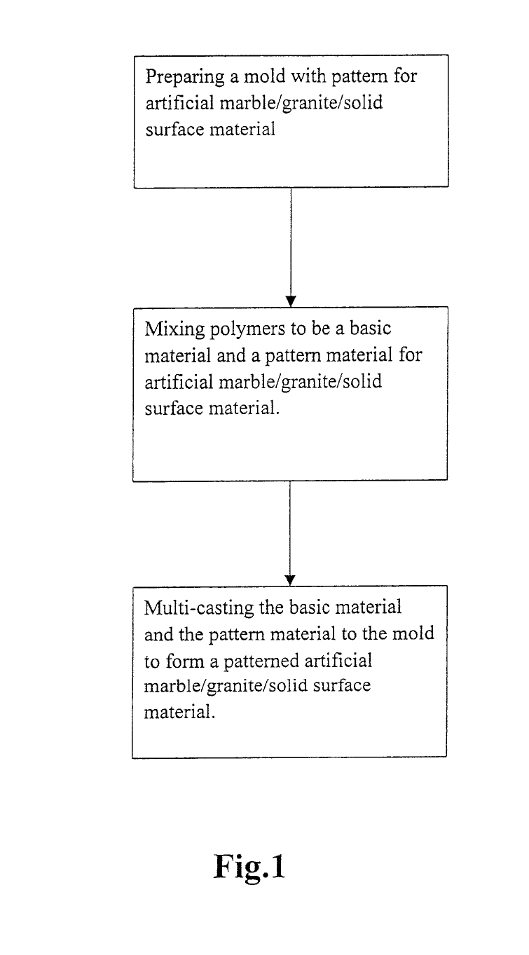

With reference to FIG. 1, the method of making patterned artificial marble/granite/solid surface material comprising the following steps:

1. Preparing a mold with a pattern for artificial marble/granite/solid surface material:

The mold is chosen for a required pattern of the artificial marble/granite/solid surface material and can be an integral mold or a composite mold with multiple segments. A wide range of materials is available for making the mold, which and includes FRP (fiberglass-reinforced plastics/fiber-reinforced plastics), metal, silica gel, Teflon™ (tetrafluoro ethylene), wood, or nylon.

2. Mixing polymers to be a basic material and a pattern material for artificial marble/granite/solid surface material:

The component of the basic material of the artificial marble/granite/solid surface material is composed of one kind of resin, at least one kind of filler material and an accelerating reagent mixed in different proportions. The component of the pattern material of the patterned artificial marble/granite/solid surface material is the same as the basic material and has different proportions of components. However, some additives such as colorful plastic grains, marble pebbles, granite pebbles are selectively added into the pattern material to make the pattern material vivid.

The resins are acrylic resin, epoxy resin, or unsaturated polyester plastics which have excellent physiochemical-resistance, corrosion-resistance, and low stress abilities. The weight proportion of the resins to total weight is 10%-90%.

The filler materials are natural marble powder, agate powder, aluminum hydroxide powder and calcium carbonate powder, and these powders are wear-resistant and of low absorbency. The weight proportion of the powder to total weight is 10%-90%.

The accelerating reagent is a chemical material which comprises cobalt salt.

The additive takes the proportion of 1-30% of the total weight of the patterned artificial marble/granite/solid surface material.

3. Multi-casting the basic material and the pattern material to the mold to form the patterned artificial marble/granite/solid surface material:

The liquefied basic material and the pattern material are poured into the mold with a pattern at least one time so that the artificial marble/granite/solid surface material is made by multi-casting. Because the accelerating reagent is sensitive to temperature, the solidification time of the patterned artificial marble/granite/solid surface material can be controlled by adjusting the concentrations of the accelerating reagents in the basic material and the pattern material, so as to make the patterned artificial marble/granite/solid surface material coagulate integrally.

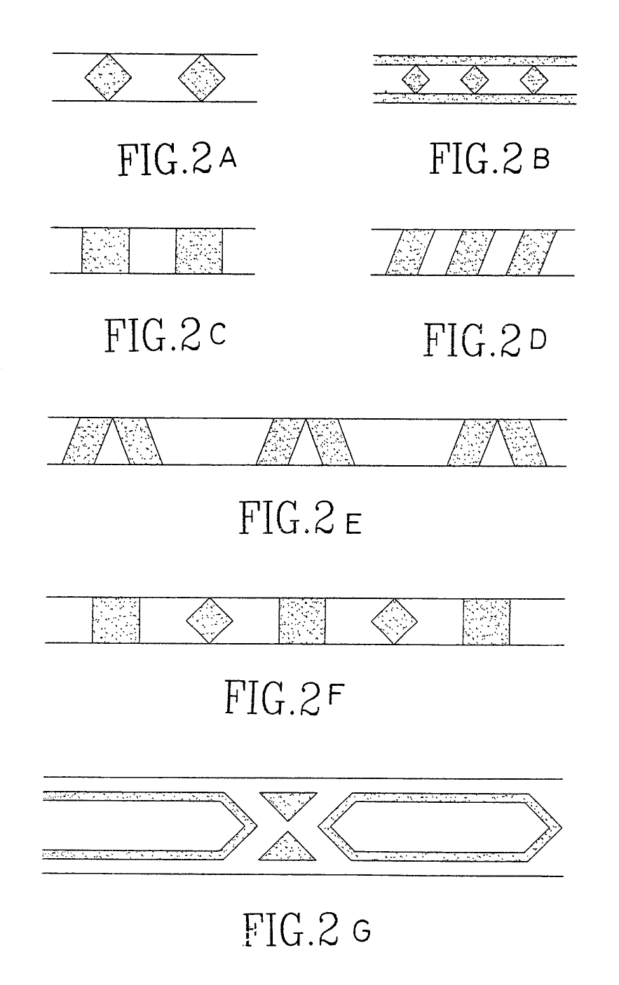

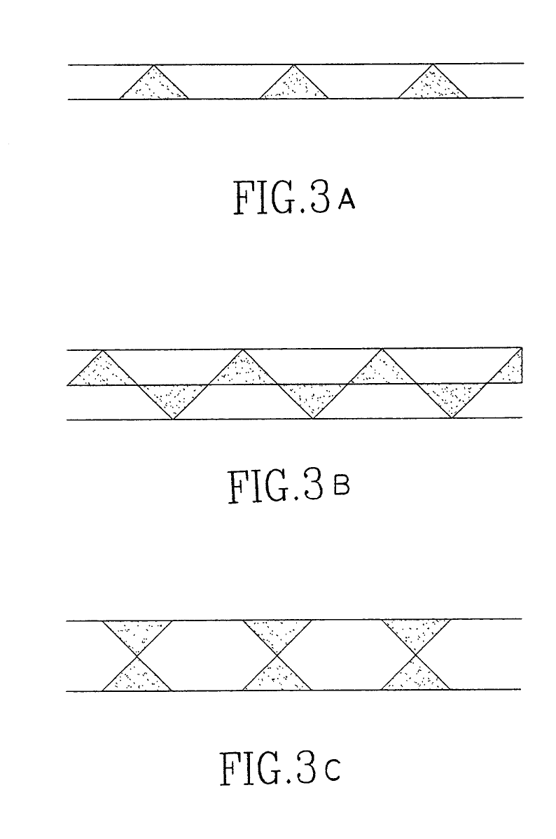

FIGS. 2A-2G show different embodiments of the patterned artificial marble/granite/solid surface material made according to the above-mentioned steps. The coagulated marble/granite/solid surface material is produced in any required size and shape without any glue, and also can be cut into any desired pieces. FIGS. 3A-3C show one jigsaw type example of the one kind of the patterned artificial marble/granite/solid surface material.

Several advantages of the method of making patterned artificial marble/granite/solid surface material are:

1. High production efficiency and low production cost:

Processing time of the patterned artificial marble/granite/solid surface material is controlled by the accelerating reagent and is much shorter than the conventional ways of making artificial marble/granite/solid surface material. Additionally, raw materials used in this method are cheap and not wasted very much because the raw materials are liquid and plastic.

2. Excellent quality:

The mold makes each single piece of the patterned artificial marble/granite/solid surface material have the same size and pattern as other pieces and have fine trimmed edges. The polymers make the patterned artificial material have excellent physiochemical-resistance, corrosion-resistance, and low stress abilities. Besides, the patterned artificial marble/granite/solid surface material is integral with no joints at all.

3. Environmental protection:

No redundant material is left to cause environmental problems.

Although the invention has been explained in relation to its preferred embodiment, it is to be understood that many other possible modifications and variations can be made without departing from the spirit and scope of the invention as hereinafter claimed.

What is claimed is:

1. A method of making a patterned artificial marble/granite/solid surface material comprising the steps:
preparing a mold with at least one pattern for producing the artificial marble/granite/solid surface material;
mixing a resin, at least one kind of filler material and an accelerating reagent to compose basic materials;
mixing a resin, at least one kind of filler material, an accelerating reagent, and additional materials to compose pattern materials; and
pouring the basic materials and the pattern materials to the mold with the at least one pattern to form the patterned artificial marble/granite/solid surface material.

2. The method of making patterned artificial marble/granite/solid surface material as claimed in claim 1, wherein the mold with at least one pattern is integral.

3. The method of making patterned artificial marble/granite/solid surface material as claimed in claim 1, wherein the mold with at least one pattern is combined from at least two pieces.

4. The method of making patterned artificial marble/granite/solid surface material as claimed in claim 1, wherein the resins are selected from the group comprising an acrylic resin, an epoxy resin, or unsaturated polyester plastics to form a main body of the patterned artificial marble/granite/solid surface material.

5. The method of making patterned artificial marble/granite/solid surface material as claimed in claim 1, wherein the filler materials are selected from the group comprising an natural marble powder, an agate powder, an aluminum hydroxide powder, and an calcium carbonate powder to form a decorative part of the patterned artificial marble/granite/solid surface material.

6. The method of making patterned artificial marble/granite/solid surface material as claimed in claim 1, wherein the additional materials are colorful materials to make the pattern material vivid.

7. The method of making patterned artificial marble/granite/solid surface material as claimed in claim 6, wherein the colorful materials are selected from the group comprising an plastic grains, marble pebbles, and granite pebbles.

8. The method of making patterned artificial marble/granite/solid surface material as claimed in claim 7, wherein the additional materials are in single color tone.

9. The method of making patterned artificial marble/granite/solid surface material as claimed in claim 7, wherein the additional materials are in multiple color tones.
